(19) United States
(12) Patent Application Publication
(10) Pub. No.: US 2012/0065913 A1
(43) Pub. Date: Mar. 15, 2012

(54) MANAGEMENT DEVICE, MANAGEMENT METHOD, AND PROGRAM RECORDING MEDIUM

(76) Inventor: TERUO SASAKI, Shizuoka (JP)

(21) Appl. No.: 13/223,806

(22) Filed: Sep. 1, 2011

(30) Foreign Application Priority Data
Sep. 10, 2010 (JP) 202634/2010

(51) Int. Cl. G06F 19/00; G01C 21/00

(52) U.S. Cl. 702/94

(57) ABSTRACT

An example of the object of the present invention is to provide a technology with which a high precision error table for an oscillation frequency is created. The present invention includes a temperature sensor which measures temperature of the oscillator used in a GPS (Global Positioning System) when a position measurement by the GPS is performed, and a management unit which measures error of an oscillation frequency of the oscillator after the position measurement by the GPS has been performed, creates and stores an error table in which the measured temperature by the temperature sensor is associated with the error.

This application is based upon and claims the benefit of priority from Japanese Patent Application No. 2010-202634, filed on Sep. 10, 2010, the disclosure of which is incorporated herein in its entirety by reference.

### TECHNICAL FIELD

The present invention relates to a management device, a management method, and a program recording medium.

### BACKGROUND ART

A receiver sensitivity of a GPS (Global Positioning System) is directly affected by precision of a clock used in the GPS. Therefore, a high precision clock is required. The clock frequency varies with the change in environment such as a temperature change, changes over time, or the like. Namely, it is known that a frequency error of the clock is generated. A technology to correct the frequency error is proposed in Japanese Patent Application Laid-Open No. 2009-222486 (patent document 1).

In the technology described in patent document 1, error of an oscillation frequency of a clock oscillator (voltage control oscillator) is measured, the oscillator is calibrated by controlling a voltage based on the measurement result, and voltage data that is associated with the temperature of the oscillator is stored whenever the calibration is performed.

However, in the technology described in patent document 1, the error of the oscillation frequency shift of the oscillator is not measured through a position measurement operation by the GPS. Therefore, the technology described in patent document 1 has a problem with precision.

### SUMMARY

An example of the object of the present invention is to provide a technology with which a high precision error table for an oscillation frequency is created.

A first exemplary invention for achieving the above-mentioned object is a management device that includes a temperature sensor which measures temperature of the oscillator used in a GPS (Global Positioning System) when a position measurement by the GPS is performed, and a management unit which measures error of an oscillation frequency of the oscillator after the position measurement by the GPS has been performed, creates and stores an error table in which the measured temperature by the temperature sensor is associated with the error.

A second exemplary invention for achieving the above-mentioned object is a management method that includes measuring temperature of the oscillator used in a GPS (Global Positioning System) when a position measurement by the GPS is performed, and measuring error of an oscillation frequency of the oscillator after the position measurement by the GPS has been performed, creating and storing an error table in which the measured temperature by the temperature sensor is associated with the error.

A third exemplary invention for achieving the above-mentioned object is a program recording medium for storing a program for a management device which causes the management device to perform a temperature measurement process for measuring temperature of the oscillator used in a GPS (Global Positioning System) when a position measurement by the GPS is performed, and a management process for measuring error of an oscillation frequency of the oscillator after the position measurement by the GPS has been performed, creating and storing an error table in which the measured temperature by the temperature sensor is associated with the error.

### BRIEF DESCRIPTION OF THE DRAWINGS

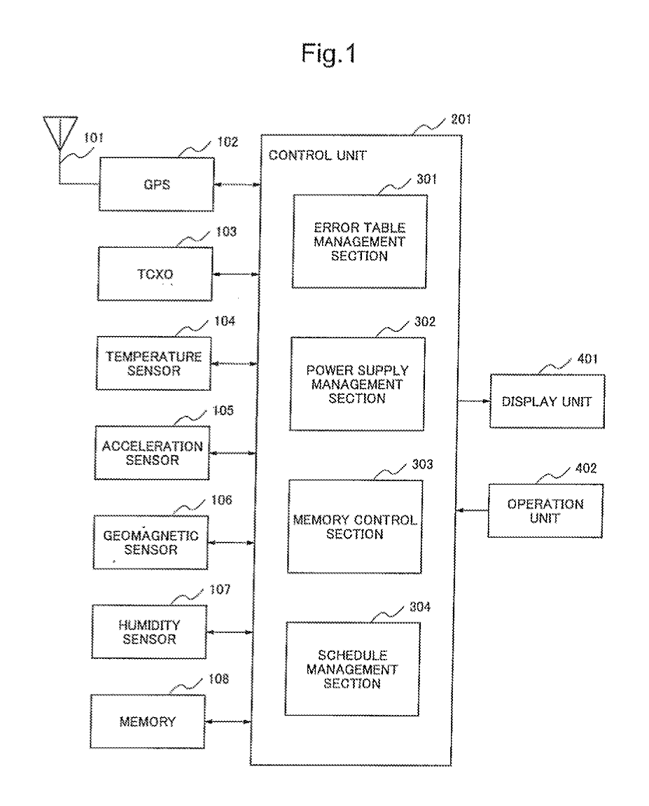

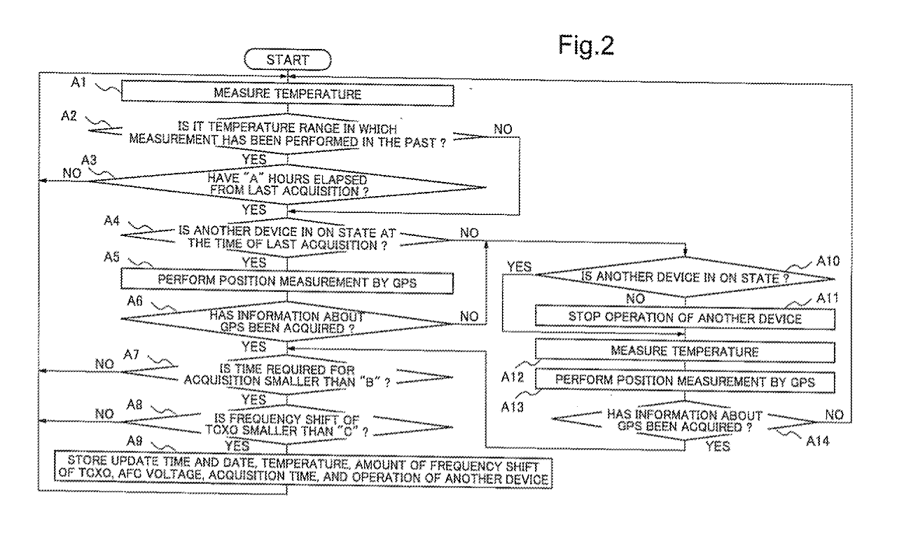

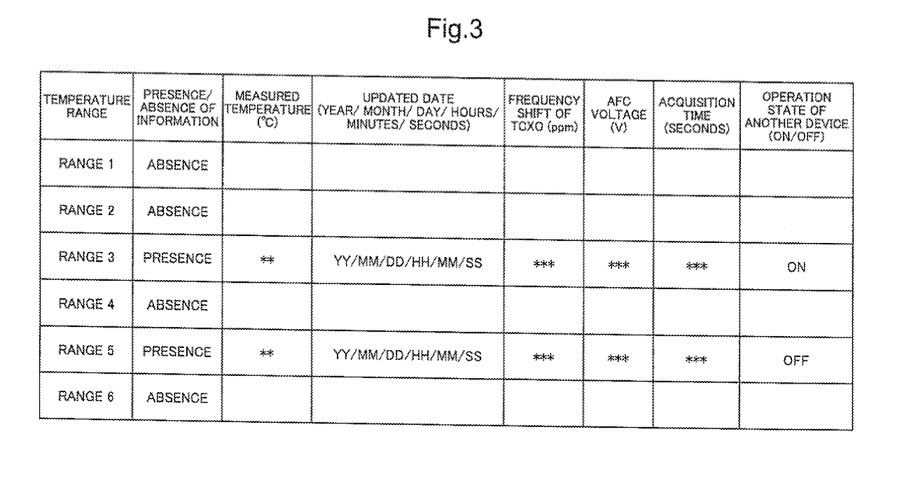

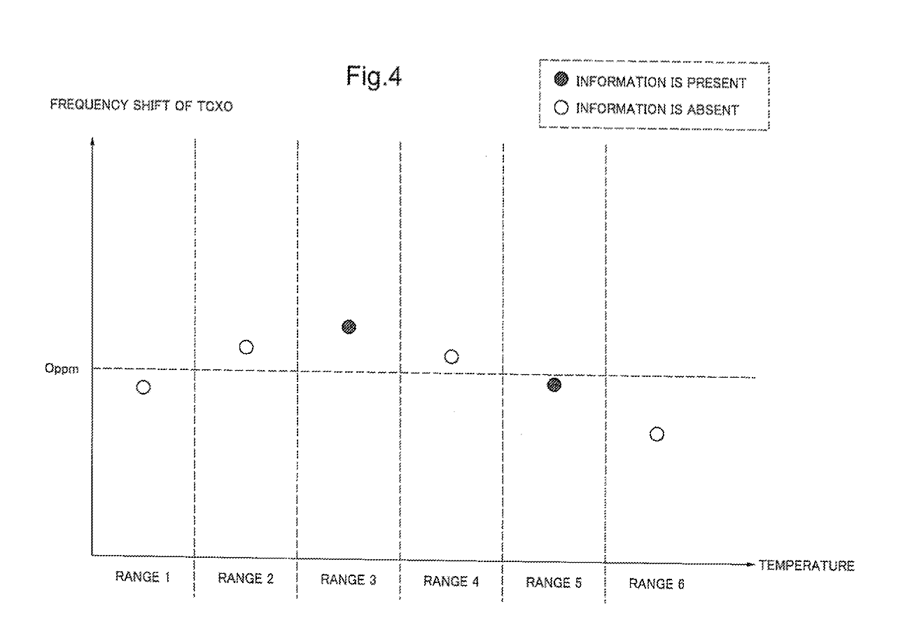

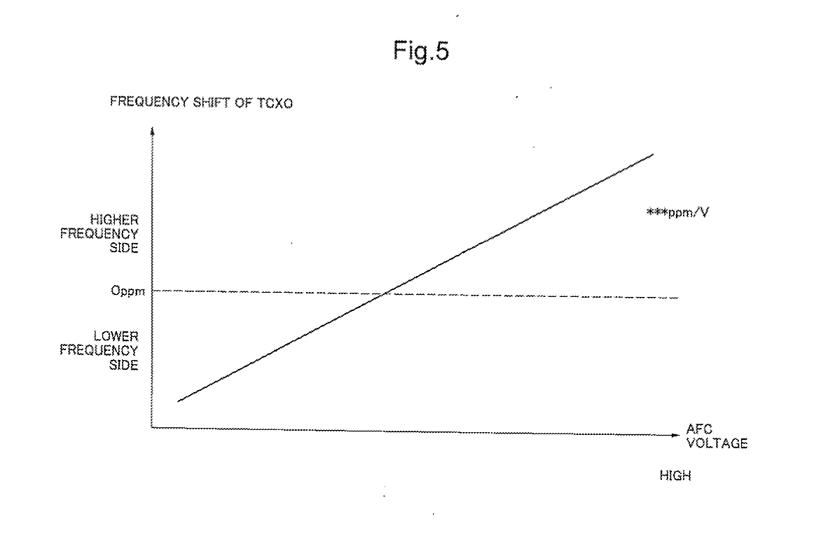

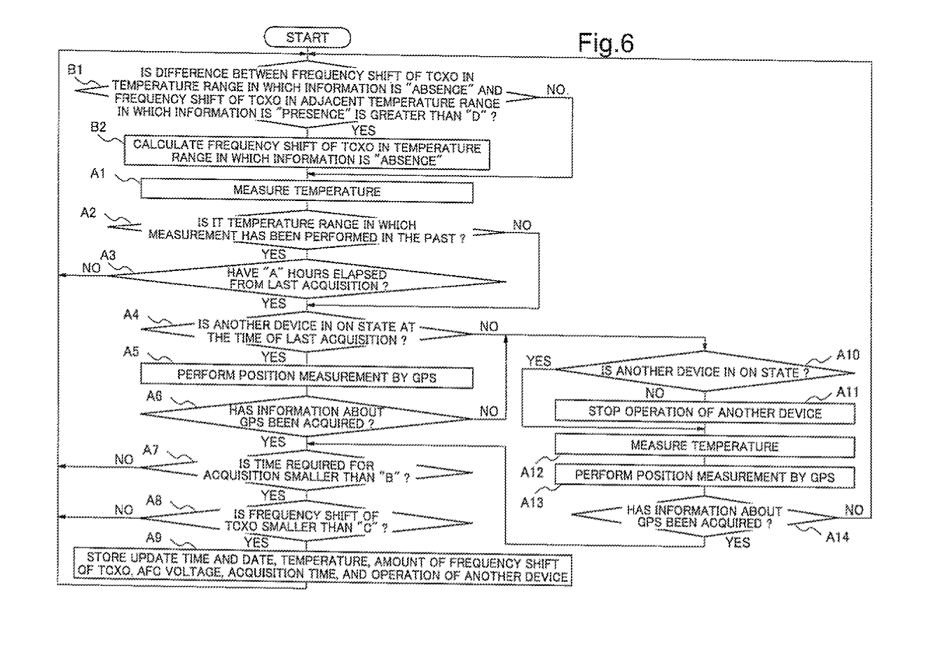

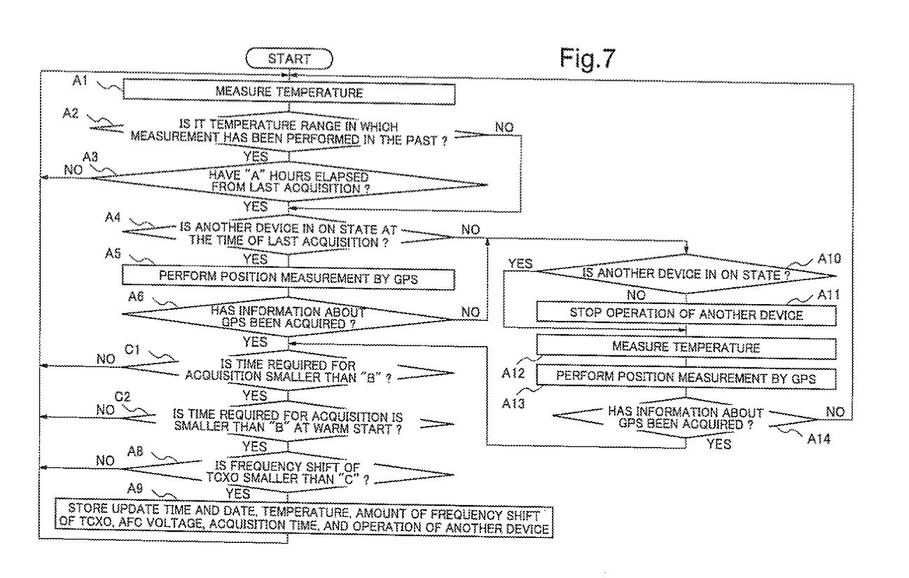

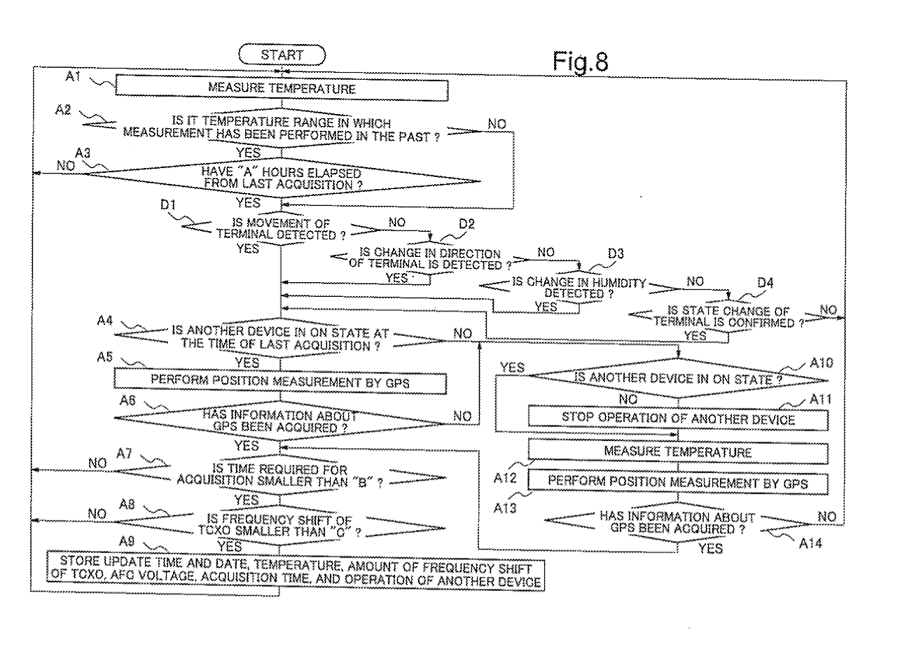

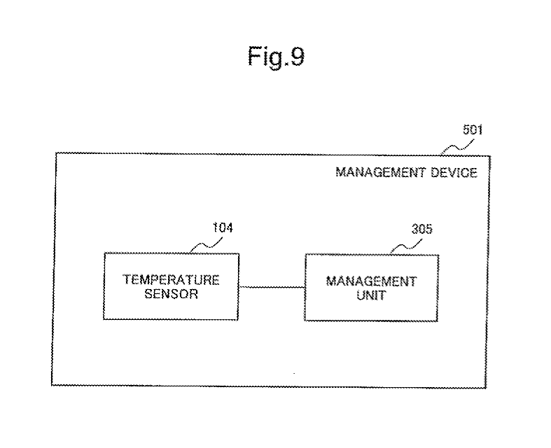

Exemplary features and advantages of the present invention will become apparent from the following detailed description when taken with the accompanying drawings in which:

[FIG. 1] FIG. 1 is a block diagram of a terminal in a first exemplary embodiment of the present invention,

[FIG. 2] FIG. 2 is a flow for explaining operation of a first exemplary embodiment,

[FIG. 3] FIG. 3 is an example of an error table,

[FIG. 4] FIG. 4 is a figure for explaining a relationship between a temperature range and a frequency shift of a TCXO with respect to presence/absence of information,

[FIG. 5] FIG. 5 is a figure for explaining a relationship between an AFC voltage and a frequency shift of a TCXO (Temperature compensated crystal oscillator),

[FIG. 6] FIG. 6 is a flowchart for explaining operation of a second exemplary embodiment of the present invention,

[FIG. 7] FIG. 7 is a flowchart for explaining operation of a third exemplary embodiment of the present invention,

[FIG. 8] FIG. 8 is a flowchart for explaining operation of a fourth exemplary embodiment of the present invention, and

[FIG. 9] FIG. 9 is a block diagram of a management device of a fifth exemplary embodiment of the present invention.

### EXEMPLARY EMBODIMENT

Feature of the present invention will be specifically described below with reference to the drawing.

The present invention relates to a management device which manages an oscillator for activating a GPS (Global Positioning System). The management device creates an error table relating to an error of the oscillation frequency of the oscillator and manages the error table to control the oscillation frequency. In each of first to fourth exemplary embodiments, explanation is made for a case in which the management device is a terminal. Namely, the first to fourth exemplary embodiments relate to a technology with which in a terminal for performing the position measurement by the GPS, a clock frequency shift is managed by the error table for each temperature in order to correct the frequency shift of the clock used when the position measurement is performed. Further, the terminal is an electronics device such as a portable terminal, a PC (Personal Computer), or the like.

### First Exemplary Embodiment

A first exemplary embodiment for performing the present invention will be described in detail with reference to a drawing.

FIG. 1 shows a configuration diagram of a terminal according to the exemplary embodiment.

The terminal includes an antenna 101, a GPS (Global Positioning System) unit 102, a reference frequency oscillator 103, a temperature sensor 104, an acceleration sensor 105, a geomagnetic sensor 106, a humidity sensor 107, a memory 108, a control unit 201, a display unit 401, and an operation unit 402. The reference frequency oscillator 103 is a temperature compensated crystal oscillator (TCXO).

The antenna 101 transmits and receives various data. The GPS unit 102 receives and acquires information for the position measurement by the GPS via the antenna 101. The reference frequency oscillator 103 generates a clock which changes a frequency based on control by the control unit 201.

The temperature sensor 104 is a device for measuring the temperature of the TCXO 103. The temperature measurement is periodically or continuously performed. The following explanation is made for a case in which the temperature measurement is performed periodically. The acceleration sensor 105 is a device for detecting acceleration of the terminal. The geomagnetic sensor 106 is a device for detecting geomagnetism. The humidity sensor 107 is a device for detecting humidity in the terminal.

The memory 108 stores the error table as shown in FIG. 3. A temperature range, presence/absence of information, a measured temperature, update time and date, a frequency shift of a clock used in a TCXO (hereinafter, referred to as “TCXO frequency shift”), an AFC voltage, an acquisition time, and operation of another device in the terminal are associated with each other and stored in the error table.

The temperature range is a range in which the TCXO frequency shift is corrected or compensated when the TCXO 103 corrects it. The temperature range may be arbitrarily determined by an administrator.

The presence/absence of information is information indicating whether or not the TCXO frequency shift has been measured in the temperature range up to now. A relationship of the presence/absence of information, the temperature range, and the TCXO frequency shift (frequency shift of the TCXO) is shown in FIG. 4. Further, the column of the presence/absence of information may be not necessarily essential. The presence/absence of information may be determined based on whether or not information is entered in the column of the TCXO frequency shift.

The measured temperature is the temperature measured by the temperature sensor 104 when the TCXO frequency shift is measured. The update time and date is a timing at which the column of the TCXO frequency shift is updated.

The AFC (Automatic frequency control) voltage is a voltage value and the control unit 201 controls a voltage for AFC based on this voltage value in order to remove the TCXO frequency shift. The voltage based on the AFC voltage (in the memory 108) is supplied from the control unit 201 to the TCXO 103 for compensating the TCXO frequency shift. The relationship between the AFC voltage and the TCXO frequency shift is shown in FIG. 5. As shown in FIG. 5, the AFC voltage and the TCXO frequency shift have the specific values, respectively. The AFC voltage is determined by a general value (ppm/V) of the TCXO and recorded in the error table. Usually, when the frequency of the TCXO is shifted to a higher frequency side, the control unit 201 decreases the AFC voltage and when the frequency of the TCXO is shifted to a lower frequency side, the control unit 201 increases the AFC voltage. Whereby, the frequency of the TCXO is adjusted.

The acquisition time is a time required for acquisition of information about the GPS. The operation of another device is information indicating whether or not another device operates when the TCXO frequency shift is measured.

The control unit 201 includes an error table management section 301, a power supply management section 302, a memory control section 303, and a schedule management section 304. The error table management section 301 controls the AFC (Automatic Frequency Control) by using the error table to control the frequency of the TCXO 103. The power supply management section 302 performs a power supply control of the various devices. Additionally, it confirms whether or not each device operates at present. Further, the power supply management section 302 measures the TCXO frequency shift. Further, any method for measuring the TCXO frequency shift can be used. The memory control section 303 creates and updates the error table of the memory 108.

The schedule management section 304 manages a user's schedule and a schedule for periodic measurement by the temperature sensor. Additionally, the schedule management section 304 measures the time and date at which the column of the TCXO frequency shift is updated and the time required for acquisition of information about the GPS. The user's schedule is used as follows, for example, when the user has a plan to move to a spot X, the user registers the acquisition of the GPS information at H (hours):M (minutes):S (seconds), for example, on Oct. 1st in 2010. Consequently, a process for acquiring the GPS information is performed at the time and date requested by the user.

The display unit 401 displays various display information on a screen. The operation unit 402 is used when the user operates the terminal.

Next, operation of the first exemplary embodiment will be described with reference a flowchart shown in FIG. 2.

The temperature sensor 104 measures the temperature periodically (process A1).

The error table management section 301 reads out the column of the presence/absence of information that is associated with the temperature range to which the measured temperature belongs from the table shown in FIG. 3 and determines whether or not the TCXO frequency shift has been measured in the past (process A2).

When “presence” is entered in the column of the presence/absence of information, the error table management section 301 reads out the column of the update time and date and determines whether or not a predetermined time “A” has elapsed from the update time and date (process A3). By this process, the TCXO frequency shift due to changes over time can be absorbed. Further, an arbitrary value “A” is set by the administrator appropriately.

In the process A2, when “absence” is entered in the column of the presence/absence of information or when the predetermined time has elapsed from the update time and date, the error table management section 301 determines whether or not another device in the terminal is in an ON state (during operation) at the time of last measurement of the TCXO frequency shift by reading out the column of the operation of another device (process A4). The operation is changed according to the ON/OFF state of another device. That is because when the TCXO frequency shift occurs, the GPS is very sensitive and the sensitivity of the GPS is degraded by the influence of another device. When another device is in the OFF state at the time of last measurement, there is a high possibility that the GPS information can be acquired when the measurement is performed in a similar environment. Therefore, the measurement is performed in a state in which another device is in the OFF state like the last measurement. As a result, a probability of acquiring the GPS information becomes high. Therefore, the electric power wastefully consumed is reduced. Further, when information about whether another device is in the ON state or in the OFF state at the time of last measurement is not entered, aprocess proceeds to “Yes”.

When it is determined in the process A4 that another device is in the ON state, the error table management section 301 searches for the TCXO frequency shift that is associated with the temperature range to which the temperature measured in the process A1 belongs on the basis of the error table and controls the AFC. When the TCXO frequency shift is entered in the column of the table, the error table management section 301 controls the AFC by using the value in the column. And the error table management section 301 controls the frequency of the TCXO 103 by the control of the AFC. The GPS unit 102 starts to perform the position measurement by the GPS under the control of the clock frequency (process A5). When the TCXO frequency shift is not entered in the column, the error table management section 301 may control the AFC by using an initial value that is set by the administrator or may not perform the control on the assumption that no frequency shift occurs. This is arbitrary.

Next, the error table management section 301 confirms whether the GPS unit 102 acquires the information about the GPS when the position measurement by the GPS is performed (process A6).

In the process A6, when the acquisition of the GPS information succeeds, the error table management section 301 receives the time required for acquisition of the GPS information from the schedule management section. The error table management section 301 determines whether the time required for acquisition of the GPS information that is received is smaller than an arbitrary value “B” (process A7). When the time required for acquisition that is received is greater than the arbitrary value “B”, there is a possibility that it takes much time to acquire the GPS information because of the TCXO frequency shift. Therefore, the process returns to the process A1. Further, the arbitrary value “B” is set by the administrator appropriately.

When it is determined that the time required for acquisition that is received is smaller than the arbitrary value “B” in the process A7, the error table management section 301 determines whether the TCXO frequency shift is smaller than an arbitrary value “C” (process A8). Usually, it is desirable that the administrator appropriately sets a value corresponding to the TCXO frequency shift due to variation in temperature of the TCXO as the value “C”. The error table management section 301 may take into consideration the amount of the TCXO frequency shift due to changes over time.

When it is determined that the TCXO frequency shift is greater than the value “C” in the process A8, there is a high possibility that the TCXO frequency shift that is acquired is not correct. Therefore, the process returns to the process A1.

When it is determined that the TCXO frequency shift is smaller than the value “C” in the process A8, the error table management section 301 stores the time at which the GPS information has been acquired, temperature information at that time, the amount of the TCXO frequency shift, the time required for the acquisition of the GPS information, and information on the ON/OFF state of another device when the GPS information has been acquired, in the error table of the memory 108 (process A9). The process returns to the process A1.

When it is determined that another device is in the OFF state in the process A4 or when it is confirmed that the GPS information is not acquired in the process A6, the power supply management section 302 confirms whether a current state of another device is the ON state (process A10).

When it is determined that the current state of another device is the OFF state in the process A10, the power supply management section 302 stops the operation of another device temporarily (process A11). The temporary stop continues until the end of the process A14. Another device is a device such as the acceleration sensor 105, the geomagnetic sensor 106, the humidity sensor 107, or the like that is not required for the position measurement by the GPS. In this exemplary embodiment, the operation of another device is forcibly stopped temporarily. However, this may be performed after the end of the operation. Further, the operation of the temperature sensor 104 may be stopped after the process A12 has been performed. The order of execution of the processes A11 and A12 is free.

When it is determined that another device is not in the ON state in the process A10 or after the process A11 has been performed, the temperature sensor 104 measures temperature (process A12). This process is performed because there is a possibility that the temperature has changed because a time has elapsed after the process A2 has been performed.

The error table management section 301 searches for the TCXO frequency shift that is associated with the temperature range to which the temperature measured in the process A12 belongs on the basis of the error table and controls the AFC in order to control the frequency of the TCXO 103. The GPS unit 102 starts to perform the position measurement by the GPS by using the clock whose frequency is controlled (process A13). When the TCXO frequency shift is entered in the column of the table, the error table management section 301 controls the AFC by using the value in the column. When the TCXO frequency shift is not entered in the column, the error table management section 301 may control the AFC by using an initial value that is set by the administrator or may not perform the control on the assumption that no frequency shift occurs. This is arbitrary.

Next, the error table management section 301 confirms whether the GPS unit 102, acquires the information about the GPS when the position measurement by the GPS is performed (process A14). When the information is not acquired by the GPS unit 102, the process returns to the process A1. When the information is acquired, the process proceeds to the process A7.

Further, in the above-mentioned operation, when the GPS information can be acquired by activating the GPS by a user' operation, the terminal of this exemplary embodiment can update the information on the error table by performing the processes after the process A7. The terminal of this exemplary embodiment acquires the GPS information, by using the TCXO frequency shift in which high precision is realized by using the error table created by the above-mentioned process like the process A5.

In the above-mentioned operation, once the position measurement by the GPS is performed in either a case in which the operation of another device is stopped or a case in which another device is operated, after that, the measurement of the TCXO frequency shift is performed in the same condition. This is because the GPS is very sensitive and once it cannot be acquired by the influence of another device, there is a high possibility that it cannot be acquired subsequently. However, even when the operation of another device is stopped, there is a possibility that the terminal of this exemplary embodiment can acquire the GPS information when a reception level of the GPS is high. Accordingly, even when the operation of another device is stopped at the time of the last acquisition, in the process A4, the process may proceed to the process A5 periodically by considering energy saving.

By performing the above-mentioned process, the terminal of this exemplary embodiment can create the high precision error table for the TCXO. Therefore, the terminal for this exemplary embodiment can use the high precision TCXO at the time of the operation of the GPS.

Once the position measurement by the GPS is performed in either a case in which the operation of another device is stopped or a case in which another device is operated, after that, the measurement of the TCXO frequency shift is performed in the same condition. Therefore, the GPS operation performed in vain can be eliminated and it is useful for energy saving.

When another device uses the TCXO, performance improvement can be expected by using the high precision TCXO that uses the above-mentioned error table.

### Second Embodiment

Next, the second exemplary embodiment will be described with reference to FIG. 1 and FIG. 6. The control unit 201 controls the oscillation frequency for the error (the TCXO frequency shift) when the measured temperature by the temperature sensor is not associated with the error in the error table, on the basis of an error associated with a temperature that is close to the measured temperature. Further, the same reference numbers are used for the elements having the same function as the above-mentioned exemplary embodiment and the detailed description will be omitted.

In the error table management section 301 of the second exemplary embodiment, it is determined whether or not a difference between the TCXO frequency shift in the temperature range in which the column of the presence/absence of information in the error table is “presence” and the TCXO frequency shift in the adjacent temperature range in which the column of the presence/absence of information is “absence” is greater than an arbitrary value “D”. This is a difference between the error table management section 301 of the first exemplary embodiment and that of the second exemplary embodiment. For example, in case of the error table shown in FIG. 3, with respect to the column of the presence/absence of information, the “presence” and the “absence” are adjacent to each other for “range 2” and “range 3”, “range 3” and “range 4”, “range 4” and “range 5”, and “range 5” and “range 6”. Accordingly, the error table management section 301 determines whether the difference between the TCXO frequency shift in the “range 2” and the TCXO frequency shift in the “range 3” is greater than the arbitrary value “D”. Similarly, this operation is performed with respect to the “range 3” and the “range 4”, the “range 4” and the “range 5”, and the “range 5” and the “range 6”. Further, it is desirable that a value corresponding to the TCXO frequency shift due to variation in temperature of the TCXO is set as the arbitrary value “D”. The amount of the TCXO frequency shift due to changes over time may be taken into consideration.

Moreover, when the error table management section 301 determines that the TCXO frequency shift is greater than the arbitrary value “D”, it performs correction so that the difference between the frequency shifts of the TCXO becomes equal to or smaller than the arbitrary value “D”. For example, as shown in FIG. 3, the column of the presence/absence of information in the “range 4” is “presence”, and the column of the presence/absence of information in the “range 3” and the column of the presence/absence of information in the “range 5” that are adjacent to the “range 4” are “absence”. In this case, the error table management section 301 corrects the TCXO frequency shift so that the TCXO frequency shift becomes equal to the TCXO frequency shift whose temperature is lower than the other. Namely, the correction is performed so that the TCXO frequency shift becomes equal to the TCXO frequency shift in the “range 3”. The error table management section 301 may perform the correction so that the TCXO frequency shift becomes equal to the TCXO frequency shift whose temperature is higher than the other. Further, the error table management section 301 may perform the correction so that the TCXO frequency shift becomes equal to a value intermediate between the TCXO frequency shift whose temperature is lower than the other and the TCXO frequency shift whose temperature is higher than the other.

Next, operation of this exemplary embodiment will be described with reference to FIG. 6. In this exemplary embodiment, processes B1 and B2 are added. This is a difference between the first exemplary embodiment and the second exemplary embodiment.

Before performing the process A1, the error table management section 301 determines whether or not a difference between the TCXO frequency shift in the temperature range in which the column of the presence/absence of information in the error table is “absence” and the TCXO frequency shift in the adjacent temperature range in which the column of the presence/absence of information is “presence” is greater than the arbitrary value “D” (process B1). When the difference between the frequency shifts of the TCXO is not greater than the arbitrary value “D”, the process proceeds to the process A1.

On the other hand, when the difference between the frequency shifts of the TCXO is greater than the arbitrary value “D” (“YES” determination), the error table management section 301 performs the correction so that the difference between the TCXO frequency shift in one temperature range in which the column of the presence/absence of information is “presence” and the TCXO frequency shift in another adjacent temperature range in which the column of the presence/absence of information is “absence” in the error table becomes equal to or smaller than the arbitrary value “D”.

By using this exemplary embodiment, even for data in the temperature range in which data of the TCXO has not been acquired, the data can be corrected so as to have a certain level of precision.

### Third Exemplary Embodiment

Next, a third exemplary embodiment will be described with reference to FIG. 1 and FIG. 7. Further, the same reference numbers are used for the elements having the same function as the above-mentioned exemplary embodiment and the detailed description will be omitted. A configuration and an operation different from those of the first exemplary embodiment or the second exemplary embodiment will be described.

With respect to the start of the position measurement operation of the GPS, there are two cases, one is a case (warm) in which the GPS has information on a GPS network (for example, parameter information required for the position measurement such as orbit information or the like) and a case (cold) in which the GPS has no such information. The time required for the acquisition of the GPS information in the warm case is different from that in the cold case. Therefore, the error table management section 301 determines the acquisition time that corresponds to each of the warm case and the cold case. The columns are added in the error table for separately managing the warm case and the cold case.

Next, operation of this exemplary embodiment will be described with reference to FIG. 7. In this exemplary embodiment, processes C1 and C2 are added. This is a difference between the third exemplary embodiment and the first exemplary embodiment or the second exemplary embodiment. In the following description, the explanation is made by using an operation in a case in which this exemplary embodiment is applied to the first exemplary embodiment.

When it is determined that the GPS information has been acquired in the process A6, any one of the following processes is performed.

When the GPS has no information on the GPS network (Cold), the error table management section 301 determines whether the acquisition time is smaller than the acquisition time that corresponds to the cold case (process C1).

On the other hand, when the GPS has the information on the GPS network (Warm), the error table management section 301 determines whether the acquisition time is smaller than the acquisition time that corresponds to the warm case (process C2).

In this exemplary embodiment, by including the determination of the acquisition time that corresponds to each of the warm case and the cold case, accuracy of the GPS operation can be obtained. As a result, the reliability of the error table is improved.

### Fourth Exemplary Embodiment

Next, a fourth exemplary embodiment will be described with reference to FIG. 1 and FIG. 8. Further, the same reference numbers are used for the elements having the same function as the above-mentioned exemplary embodiment and the detailed description will be omitted. A configuration and an operation different from those of the first exemplary embodiment, the second exemplary embodiment, or the third exemplary embodiment will be described.

The schedule management section 304 investigates whether or not the position measurement environment is changed after the time of the last position measurement by the GPS before performing the position measurement by the GPS of the process A5. When it is determined that the environment does not change based on the result of the investigation, the schedule management section 301 performs control so that the position measurement by the GPS is not performed by the GPS unit 102. The change in the position measurement environment is the change in the environment by which the precision of the position measurement by the GPS is affected. For example, the change in the position measurement environment is at least one of movement of the terminal, the direction of the terminal, the change in the humidity of the terminal, and the state change of the terminal by the operation of the various terminals that is performed by the schedule management section 304. The movement of the terminal is detected by the acceleration sensor 105. The direction of the terminal is detected by the geomagnetic sensor 106. The change in the humidity is detected by the humidity sensor 104. The state change of the terminal by the various operations of the terminal that is performed by the schedule management section 304 is confirmed by the schedule held by the schedule management section 304. In the following description, the explanation is made for a case in which this exemplary embodiment is applied to the first exemplary embodiment.

Next, operation of this exemplary embodiment will be described with reference to FIG. 8. When the movement of the terminal is not detected by the acceleration sensor (process D1), the change in the direction of the terminal is not detected by the geomagnetic sensor (process D2), the change in the humidity is not detected by the humidity sensor (process D3), or the state change of the terminal by the various operations of the terminal is not confirmed by the schedule management section 304 (process D4), the terminal of this exemplary embodiment does not perform the position measurement by the GPS and the process proceeds to the process A4.

By using this exemplary embodiment, the energy saving can be attained. This is because when the environment of the terminal does not change, there is a high possibility that the frequency of the TCXO is not shifted and the terminal of this exemplary embodiment does not perform the position measurement by the GPS in a case in which the environment does not change.

Further, as is clear from the above-mentioned explanation, the above-mentioned terminal of the present invention can be realized by hardware. However, it can be realized by a computer program. The function and the operation of the exemplary embodiment mentioned above may be realized by a processor that is operated by a program stored in a program memory. Additionally, only a part of the function of the above-mentioned exemplary embodiment can be realized by the computer program.

### Fifth Exemplary Embodiment

Next, a fifth exemplary embodiment will be described with reference to FIG. 9. Further, the same reference numbers are used for the elements having the same function as the above-mentioned exemplary embodiment and the detailed description will be omitted.

As shown in FIG. 9, a fifth exemplary embodiment is a management device 501 including the temperature sensor 104 and the management unit 305.

The temperature sensor 104 measures temperature of the oscillator used in a GPS (Global Positioning System) when a position measurement by the GPS is performed.

The management unit 305 measures error of an oscillation frequency of the oscillator after the position measurement by the GPS has been performed, creates and stores an error table in which the measured temperature by the temperature sensor is associated with the error.

By using this exemplary embodiment, the high precision error table for the oscillation frequency can be created.

In the inventions explained above, the first invention is the management device which includes a temperature sensor which measures temperature of the oscillator used in a GPS (Global Positioning System) when a position measurement by the GPS is performed, and a management unit which measures error of an oscillation frequency of the oscillator after the position measurement by the GPS has been performed, creates and stores an error table in which the measured temperature by the temperature sensor is associated with the error.

The second invention is the management method that includes measuring temperature of the oscillator used in a GPS (Global Positioning System) when a position measurement by the GPS is performed, and measuring error of an oscillation frequency of the oscillator after the position measurement by the GPS has been performed, creating and storing an error table in which the measured temperature by the temperature sensor is associated with the error.

The third invention is a program recording medium that stores a program for the management device. The program recording medium stores a program which causes the management device to perform a temperature measurement process for measuring temperature of the oscillator used in a GPS (Global Positioning System) when a position measurement by the GPS is performed, and a management process for measuring error of an oscillation frequency of the oscillator after the position measurement by the GPS has been performed, creating and storing an error table in which the measured temperature by the temperature sensor is associated with the error.

By using the present invention described in each exemplary embodiment, the high precision error table for the TCXO can be obtained. Therefore, the present invention can cope with the variation in error due to the change in the temperature of the TCXO. The present invention can cope with the variation in error due to changes over time of the TCXO. Further, the present invention can cope with the variation in error due to the change in the environment of the TCXO. Furthermore, by using the present invention, the high precision error table for the TCXO can be obtained and the energy saving can be attained.

The present invention has been explained above based on the exemplary embodiment. However, the present invention is not limited to the above-mentioned exemplary embodiment and example. Various changes can be made without departing from the technical idea of the invention.

What is claimed is:

1. A management device comprising:
a temperature sensor which measures temperature of the oscillator used in a GPS (Global Positioning System) when a position measurement by the GPS is performed, and
a management unit which measures error of an oscillation frequency of the oscillator after the position measurement by the GPS has been performed, creates and stores an error table in which the measured temperature by the temperature sensor is associated with the error.

2. The management device described in claim 1, wherein when acquisition of information about the GPS is failed in the position measurement, the management unit controls the GPS to perform the position measurement after stopping a device not required for the position measurement by the GPS.

3. The management device described in claim 1, wherein the management unit determines whether or not to measure the error of the oscillation frequency according to an acquisition time of the information about the GPS in the position measurement.

4. The management device described in claim 3, wherein the management unit sets the acquisition time according to whether or not a parameter required for the position measurement by the GPS is held.

5. The management device described in claim 1, wherein the management unit controls the oscillation frequency for the error when the measured temperature is not associated with the error in the error table, on the basis of the error associated with a temperature that is close to the measured temperature.

6. The management device described in claim 1, wherein the management unit monitors a change in environment of the position measurement and controls the GPS not to perform the position measurement when the change is not observed.

7. The management device described in claim 1 further including display unit for displaying a result of the position measurement by the GPS.

8. The management device described in claim 1, wherein the management unit determines whether a frequency shift of a TCXO is measured in the past from the error table managed thereby and updates the error table when it is determined that it is not measured or when it is determined that a predetermined time has elapsed from an update time and date.

9. The management device described in claim 8, wherein when it is determined that the TCXO frequency shift is measured in the past, it is determined whether or not another device has been operated, a process for updating the error table is performed when it is determined that it has been operated, and another device currently operated is stopped and after that, the error table is updated when it is determined that it has not been operated.

10. A management method comprising:
measuring temperature of the oscillator used in a GPS (Global Positioning System) when a position measurement by the GPS is performed, and
measuring error of an oscillation frequency of the oscillator after the position measurement by the GPS has been performed, creating and storing an error table in which the measured temperature by the temperature sensor is associated with the error.

11. A program recording medium for storing a program which causes a management device to perform:
a temperature measurement process for measuring temperature of the oscillator used in a GPS (Global Positioning System) when a position measurement by the GPS is performed, and
a management process for measuring error of an oscillation frequency of the oscillator after the position measurement by the GPS has been performed, creating and storing an error table in which the measured temperature by the temperature sensor is associated with the error.
